(19) United States
(12) Patent Application Publication
(10) Pub. No.: US 2009/0157473 A1
(43) Pub. Date: Jun. 18, 2009

(54) SYSTEM AND METHOD FOR SENDING TARGETED MARKETING DATA USING PROXIMITY DATA

(75) Inventors: Steven Belz, Cedar Park, TX (US); Marc Andrw Sullivan, Austin, TX (US); James Pratt, Round Rock, TX (US)

Correspondence Address: AT&T Legal Department - Roebuck;Attn: Patent Docketing, One AT&T Way,, Room 2A-207, Bedminster, NJ, 07921, US

(73) Assignee: ATT Knowledge Ventures L.P., Reno, NV (US)

(21) Appl. No.: 11/958,825

(22) Filed: Dec. 18, 2007

(51) Int. Cl. G06F 17/00; G06Q 30/00

(52) U.S. Cl. 705/10; 705/14

(57) ABSTRACT

A method for selecting advertising data is disclosed, the method comprising monitoring proximity data indicating proximity between a first end user device and at least one second device; examining historical behavior profile data for the second device; placing data from the historical behavior profile data into an opportunity profile for the first end user based on the proximity data; and sending advertising data to the first end user device relating to the data in the opportunity profile. A system is disclosed for performing the method. A data structure embedded in a computer readable medium is disclosed for containing data used by the system and method.

### FIELD OF THE DISCLOSURE

The present disclosure relates to the field of targeted advertising.

### BACKGROUND OF THE DISCLOSURE

The goal of advertising is to transform potential consumers into actual customers. Further, people have demonstrated a willingness to review advertisements in exchange for unrelated goods and services (e.g., viewing an automobile advertisement before watching a video on a website). The challenge for the advertiser is to ensure an efficient advertising strategy—that their advertisement will be viewed by a potential consumer. Marketing programs are efficient when they are able to convey information to the correct population demographic without incurring the expense of conveying information to population demographics who will probably not purchase the advertised goods or services. An efficient strategy is useful for the advertiser as they are able to adopt a strategy where they are more likely to approach potential consumers. Efficient marketing programs are also useful for the intended recipient because they are not exposed to advertisements for which they are not the intended audience.

### BRIEF DESCRIPTION OF THE DRAWINGS

FIG. 1 depicts an illustrative embodiment of a data structure system and method for delivering advertising data;

FIG. 2 depicts another data structure, system and method for delivering advertising data;

FIG. 3 depicts a scenario in which proximity data are retained for end user devices;

FIG. 4 depicts a flow chart of functions performed in another illustrative method for delivering advertising data;

FIG. 5 depicts an illustrative embodiment of a system for providing advertising data to end user devices; and

FIG. 6 depicts an illustrative embodiment of a machine for performing functions disclosed in another illustrative embodiment.

### DETAILED DESCRIPTION

Previous efforts to generate efficient marketing programs have focused on readily available demographic data (e.g., address and income) in determining which advertisements should be included in various forms of print media. They have also focused on ascertaining the demographics of individuals watching a particular television show in order to determine which advertisements should be shown during that show. Neither strategy takes into account the effect personal interaction has on product selection. For example, one might purchase a TV because their brother has one just like it and he is happy with his selection. One might also want to try a new type of beer because they have tried it at their neighbor's house (but can not remember the name of it, or need a coupon that would provide incentive). The strategy proposed herein uses a wireless device to monitor and maintain a social interaction profile to determine what products and services should be marketed to the owner of that device. This disclosure offers a novel mechanism for improving the efficiency of targeted marketing by discovering a social network for an end user and maturating products from the social network to the end user.

There are a variety of different technology implementations that an illustrative embodiment of this disclosure can manifest. In a particular illustrative embodiment, three components are provided. A proximity device capable of identifying and exchanging proximity tokens data, hereinafter referred to as proximity data with other end user devices with proximity capability (also referred to herein as end user devices or end user proximity devices) (e.g., wireless phone, implantable chip). A second device providing the capability to record and maintain a record of an end user's purchases (e.g., credit card record, phone working in conjunction with place of business) and other end user activity data such as physical and/or social proximity to persons, places or things as indicated by proximity data. A third device such as a centralized network server (accessible by high speed cellular, Bluetooth, IR, wireless fidelity (WiFi)) capable of comparing the purchase and proximity data for people identified by the proximity data collected in order to generate an opportunity profile which identifies targeted advertising opportunities. In one particular embodiment, a phone number is represented as a proximity token with proximity token data.

In an illustrative embodiment, proximity data are another key or number which is unique to the user of the device. In another particular embodiment, a device is provided for identifying Proximity Token recipients through proximity data. Proximity may be dependent on time (e.g., two people located physically near or proximate each other regardless of location at or near the same time) when a proximity event occurs through the use of near range wireless technology (e.g., Pico cell, Bluetooth, IR, WiFi) in exchanging proximity data. The exchange or receipt of proximity data occurs when a proximity event occurs, such as when two end users devices come within a predetermined distance of each other or electronically communicate with each other. In another embodiment, proximity may be dependent on time and location (e.g., two people located near each other at a particular place and time—such as an event at a particular location). In another particular embodiment, proximity may only be dependent on location (e.g., two people located near a common proximity device regardless of the time of each proximity event) where identification may involve a third party proximity device which collects proximity token data through the use of near range wireless technology (e.g., Pico cell, Bluetooth, IR, WiFi) at one point in time from one end user device and rebroadcasts the proximity data token a second time to another end user proximity device).

In another embodiment sharing or exchanging of proximity data is provided includes but is not limited to sending and receiving proximity data. Proximity data may be entered manually (e.g., phone number), or the token data may be transmitted electronically through a near range wireless technology (e.g., Pico cell, Bluetooth, IR, WiFi). The proximity data is transmitted or communicated to a centralized network facility through a networking technology (e.g., including but not limited to fiber optic, cellular network, WiFi). At a centralized server in a communication system, a processor and computer instructions are provided to link the proximity data to a data structure containing data indicating a record of historical purchasing and proximity behavior for a social network of end users created from the proximity data.

For example, in one embodiment, purchasing behavior is accessed by linking with a credit card company record of purchasing transactions for end users in the social network. In another embodiment, purchasing behavior is derived from using, the end user proximity device such as a mobile or cellular telephone as a payment vehicle and establishing a historical purchasing behavior for each individual end user associated with an end user proximity device. The server processor and computer program analyzes historical purchasing behaviors and other end user activity data to determine commonalities among records from linked proximity data from end users who are members of the social network. The server processor also updates the individual's end users Opportunity Profile based on said commonalities and identifies advertisers who match entries in the end user's Opportunity Profile. A server processor located at a content data server delivers content and advertising data based via network technology (e.g., wireless, wired) to devices of which is a known user (e.g., phone, computer, television).

Generally, those near or proximate an end user on a regular basis (herein referred to as an end user's “social network”), are more likely to have a greater influence on the end user's behaviors (and the end user on their social network). Another illustrative embodiment uses the knowledge about the buying habits of those in close physical or social proximity to an individual end user in order to determine which goods and services are marketed to that individual end user. The social interaction profile keeps track of an individual end user's purchasing behavior (e.g., historical behavior), places visited or proximity devices with which the end user is or has been physically or socially proximate and exchanged proximity data, and the future marketing opportunities (e.g., opportunity profile). The descriptions within the social interaction profiles may be comprised of categories or individual products, and services.

The social interaction profile contains data that keeps track of those end users who are in social or physical proximity. For example, physical proximity is when an end user device is within physical proximity (within a specified distance, for example, 3 feet) to an individual with an end user proximity device (proximity may be resolved through several means, such as a phone list or wireless polling of other similar devices) and generates an aggregate model in a historical behavioral profile of the goods and services used by those in proximity to the end user, that is, the end user's social network. Social proximity occurs when end users communicate with each other or store contact data (e.g., phone number, email address, etc.) for other end users. The social interaction profile is periodically updated based on the subscriber activity data and/or an individual's interactions and proximity events with other end users having end user proximity devices with which the end user exchanges proximity data.

An end user's social network expands as the end user comes within the specified distance of other end users' proximity devices. Thus, if two end users carry cell phones which are also proximity devices (i.e., end user proximity devices), and come within or specified distance of each other (e.g., 1 meter), they exchange proximity data and become potential members or each others' social network. Consider a simple series of interactions where an primary end user interacts or comes within the specified distance of six different secondary end users each having proximity devices. The six secondary end users become members of the primary end user's social network. The social interaction profile looks for similarities across each of the historical behaviors of the six secondary end users with whom this primary end user interacts. When similarities are found, a server in an illustrative embodiment populates the primary end user's opportunity profile which is used to drive the directed marketing efforts to the primary end user.

In another embodiment, a computer readable medium is disclosed containing a computer program including instructions that when executed by a computer perform a method for selecting advertising data, the method including monitoring proximity data indicating proximity between a first end user device and at least one second device; examining historical behavior profile data for the second device; placing data from the historical behavior profile data into an opportunity profile for the first end user device based on the proximity data; and selecting advertising data to be sent to the first end user device relating to the data placed in the opportunity profile. In another embodiment of the medium one of the first end user device and the second device further comprise a plurality of end user devices associated with a plurality of end users. In another embodiment of the medium the historical behavior profile further comprises purchase transaction data for an end user associated with the second device.

In another embodiment of the medium the historical behavior profile data further comprise data indicating that the second device came within a predetermined distance of a third device. In another embodiment of the medium the historical behavior profile data further comprise subscriber activity data for an end user associated with the second device. In another embodiment of the method the second end user device further comprises a plurality of end user devices associated with a plurality of end users. In another embodiment of the medium the proximity data further comprise proximity data transferred between the first end user device and the second device when the first end user device and the second device come within a predetermined distance of each other.

In another embodiment of the medium the proximity data further comprise data indicating a proximity event selected from the group consisting of the first end user device storing contact information for the second device, the first end user device sending an email to the second device, the first end user device sending a short messaging service (SMS) message to the second device and the first end user device placing a phone call to the second device. In another embodiment of the medium the proximity data further comprises proximity data for the first end user device transferred between the first end user device and a third device when the first end user device and the third device come within a first predetermined range of each other; and proximity data for the first end user device transferred from the third device to the second device when the second device and the third device come within a second predetermined range of each other. In another embodiment of the medium the proximity data are weighted based on a factor selected from the group consisting of time of day, day of the week and frequency of occurrence of the proximity event. In another embodiment of the medium the historical behavioral profile data further comprise data indicating the first end user device and second device coming within a predetermined distance of a third device within a predetermined time. In another embodiment of the medium the proximity data indicates that the first end user device and the second device are associated with end users in a social network.

In another embodiment, a system is disclosed for selecting advertising data, the system including a processor in data communication with a computer readable medium; and a computer program stored in the computer readable medium containing computer executable instructions, the computer program comprising instructions to monitoring proximity data indicating proximity between a first end user device and at least one second device, instructions to examine a historical behavior profile data for the second device, instructions to place data from the historical behavior profile data into an opportunity profile for the first end user device based on the proximity data and instructions to select advertising data to be sent to the first end user device relating to the data placed in the opportunity profile.

In another embodiment of the system one of the first end user device and the second device further comprise a plurality of end user devices associated with a plurality of end users. In another embodiment of the system the historical behavior profile further comprises purchase transaction data for an end user associated with the second device. In another embodiment of the system the historical behavior profile data further comprise data indicating that the second device came within a predetermined distance of a third device. In another embodiment of the system the historical behavior profile data further comprise subscriber activity data for an end user associated with the second device. In another embodiment of the system the second end user device further comprises a plurality of end user devices associated with a plurality of end users. In another embodiment of the system the proximity data further comprise proximity data transferred between the first end user device and the second device when the first and second devices come within a predetermined distance of each other.

In another embodiment of the system the proximity data further comprise data indicating a proximity event selected from the group consisting of the first end user device storing contact information for the second device, the first end user device sending an email to the second device, the first end user device sending a short messaging service (SMS) message to the second device and the first end user device placing a phone call to the second device. In another embodiment of the system the proximity data further comprises proximity data for the first end user device transferred between the first end user device and a third device when the first end user device and the third device come within a first predetermined range of each other; and proximity data for the first end user device transferred from the third device to the second device when the second device and the third device come within a second predetermined range of each other. In another embodiment of the system the proximity data are weighted based on a factor selected from the group consisting of time of day, day of the week and frequency of occurrence of the proximity event. In another embodiment of the system the historical behavioral profile data further comprise data indicating the first end user device and second device coming within a predetermined distance of a third device within a predetermined time. In another embodiment of the system the proximity data indicates that the first end user device and the second device are associated with end users in a social network.

In another embodiment, a computer readable medium is disclosed containing computer executable instructions that when executed by a computer perform a method for receiving advertising data, the method including transferring proximity data between a first end user device and a second device indicating proximity between the first end user device and the second device; and receiving targeted advertising data at the first end user device based on data from a historical behavior profile placed into an opportunity profile for the first end user device. In another embodiment, an apparatus for receiving advertising data, the apparatus including a processor in data communication with a computer readable medium; and a computer program stored in the computer readable medium containing computer executable instructions the when executed by a computer perform a method for receiving advertising data, the computer program comprising instructions to transfer proximity data between a first end user device and a second device indicating proximity between the first end user device and the second device and instructions to receive targeted advertising data at the first end user device based on data from a historical behavior profile for the second device placed into an opportunity profile for the first end user device.

In another embodiment a data structure is disclosed embedded in a computer readable medium for containing data useful in performing a method for selecting targeted advertising data to end user devices based on proximity data, the data structure including a first field for containing proximity data indicative of a secondary end user proximity device that has come into proximity with a primary end user proximity device; a second field for containing data indicative of a historical behavior profile for a secondary end user associated with the secondary end user proximity device; and a third field for containing data indicative of an opportunity profile for a first end user associated with the first end user device wherein the data is moved from the historical behavior profile to the opportunity profile for the first end user device for selecting targeted advertising data to be sent to the first end user device based on the data in the opportunity profile.

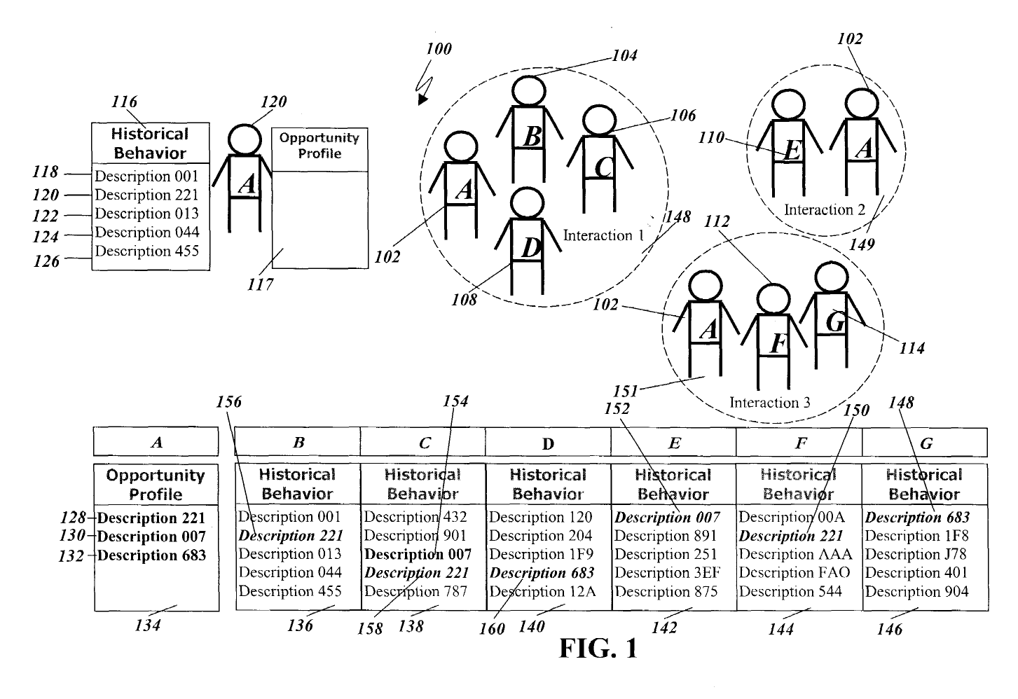

Turning now to FIG. 1, as shown in FIG. 1, a social network is created for a first end user A 102 and end user A's proximity data is exchanged with end user B 104 end user C 106 and end user D 108 end user E 110 end user F 112 and end user G 114. Each end user has an associated end-user device which exchanges proximity data with other proximity devices associated with other end-users. As shown in FIG. 1 end user A 102 has a historical behavior profile 116 and an opportunity profile 117 which are data structures containing data stored in a computer readable medium. Prior to the establishment of the population data for the opportunity profile 117 the opportunity profile 117 is unpopulated, that is, contains no data. Initially the end user A's historical behavior profile includes data items 118, 120, 122, 124 and 126. As shown in interaction 148 end user at A comes within a predetermined distance of end user B, end user C and end user D, thereby causing the end user devices associated with each end user to exchange proximity data with the initial device associated with end user A. As shown in interaction number 2 149 end user A comes within a predetermined distance of end user E, thereby initiating an exchange of proximity data between end user devices associated with end user A and the proximity device associated with end user E. As shown in interaction 3 151 end user A 102 comes within a predetermined distance of end user F 112 and end user G 114 thereby initiating exchange of proximity data between the end user device associated with end user A and the end user devices associated with end user F 112 and end user G 114.

In an illustrative embodiment when end users come within a predetermined distance of each other, they exchange proximity data and become part of a social network for a particular end user. In an illustrative embodiment end user A has come within the predetermined distance, for example 3 meters, of end user B, end user C, end user D, end user F and end user G. An illustrative embodiment examines the proximity data exchanged between end users A, B, C, D, E, F and G and determines that end user A has a social network including end users B, C, D, E, F, and G. In an alternative embodiment a computer program or device associated with the server in communication with being user devices examines the historical behavior profile data for each of the end user devices. An illustrative embodiment then examines the historical behavior profiles for each of the end user devices in the social network for end user A and determines which data elements are in common between the members of end-user A's social network. Those common items not already in end user A's historical profile are placed in end user A's opportunity profile. Thus new opportunities for end user A to receive targeted adverting data are gleaned from end user A's social network. In the present example if two historical behavior profiles in the A's social network share a common data item, that data item is placed in the opportunity profile for end user A.

As shown in FIG. 1 end user B's historical profile 136, contains a historical profile data item 156 which is common to other historical profiles in the social network of end user A and does not appear in end user A's historical profile. In the present example, data item 156 in the historical behavior profile for end user B is also found as data item 158 in the historical profile 138 for end user C. Thus the data item 156 is moved to the opportunity profile for end-user A B 4 as data item 128. Similarly historical data item 154 in end user C's historical profile is also found in the historical behavior profile 142 for end user D as data item 152. Thus the data item 154 is moved to the opportunity profile for end user at A as data item 130. Similarly historical data item 160 in end user historical profile D is also found in the historical behavior profile 146 for end user G as data item 148. Thus the data item 160 is moved to the opportunity profile for end user at A as data item 132. In an illustrative embodiment, targeted advertising data for data items 128, 130 and 132 in the opportunity profile for end user A are sent to the end user device associated with end user A.

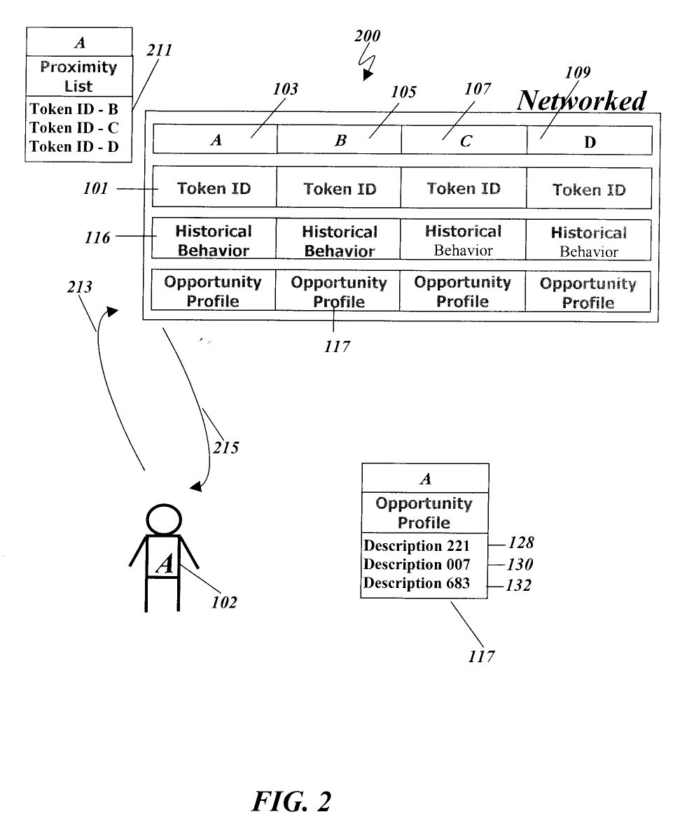

As shown in FIG. 2 a networked system includes but is not limited to a proximity list 211 for end-user A. The proximity list (a data structure containing data stored in a computer readable medium indicates a social network (a group of end users) for end user A. The proximity list contains data indicating tokens for end-user devices with which end user A's end user proximity device has come within proximity of or within a predetermined distance. Thus when end user proximity devices B, C and D come within the predetermined distance of end user A's proximity device (which is also referred to herein as a proximity event), they exchange proximity data with end user proximity device A. Thus data indicating occurrence of the proximity event are placed in the proximity list 211 for end-user device A.

Similar to the process described above with reference to FIG. 1, in an illustrative embodiment a function or device examines the historical behavior profiles for each of the end user devices in the proximity list which comprise end user A's social network and places those data items that are in common in the historical profiles for the end user A's social network into end user A's opportunity profile 117 where they appear as data items 128, 130 and 132. Targeted advertising data associated with opportunity profile for end user A data items 128, 130 and 132 are sent to the end user device associated with end user A. As shown in FIG. 2, each end user associated with an end user proximity device, end user A 103, B 105, C 107 and D 109 has a data structure in a computer readable medium having an associated token ID field 101 for storing data indicative of a token identifier, a historical behavior profile field 116 for storing data indicative of a historical behavior profile and an opportunity profile field 117 for storing data indicative of an opportunity profile for each of the end users associated with an end-user device.

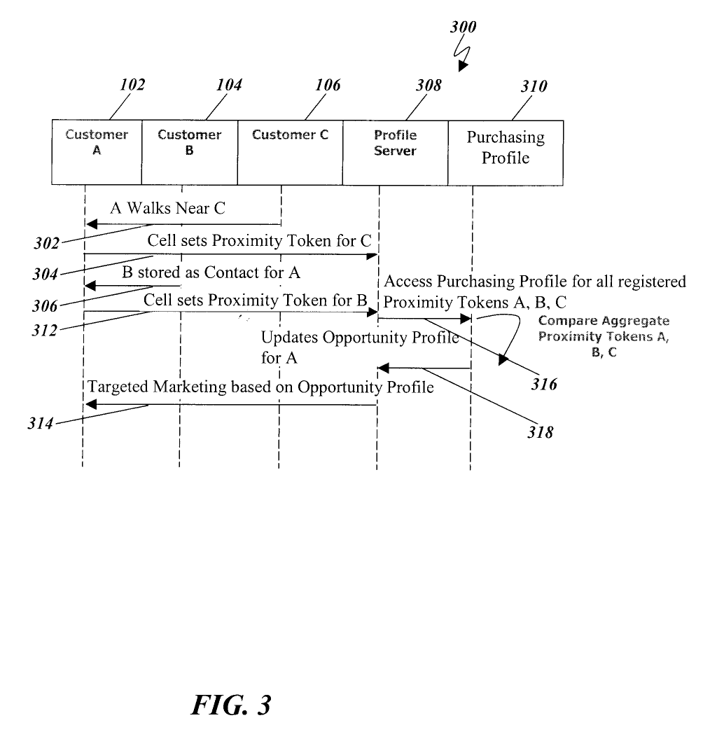

Turning now to FIG. 3 in another embodiment proximity events occur between end users A 102, B 104 and C 106. The proximity event data is logged in data structures at a profile server 308 and entered into fields in the data structure for a historical behavior profiles such as a purchasing profile 310. As shown in FIG. 3 when end user A walks near end user C 302, that is comes within a predetermined distance of end user C, an illustrative embodiment sends 304 proximity token data for end user C to the profile server 308 indicating a proximity event has occurred between end user A and end user C. Similarly when end user A stores contact information data for end user B, (phone number, email address) an illustrative embodiment sends proximity token data for end user B into the proximity list for end user A, placing end user B in end user A's social network, that is, places end user B in the proximity list for end user A at 316. An illustrative embodiment accesses the historical behavior profiles for all registered proximity tokens data for end user A's proximity list and compares the aggregate proximity data for each of end users A, B and C. At 318 an illustrative embodiment updates an opportunity profile for end user A based upon those proximity events and historical profiles for end users B and C. At 314 targeted marketing data based upon the updated opportunity profile for end user A is sent to end user A.

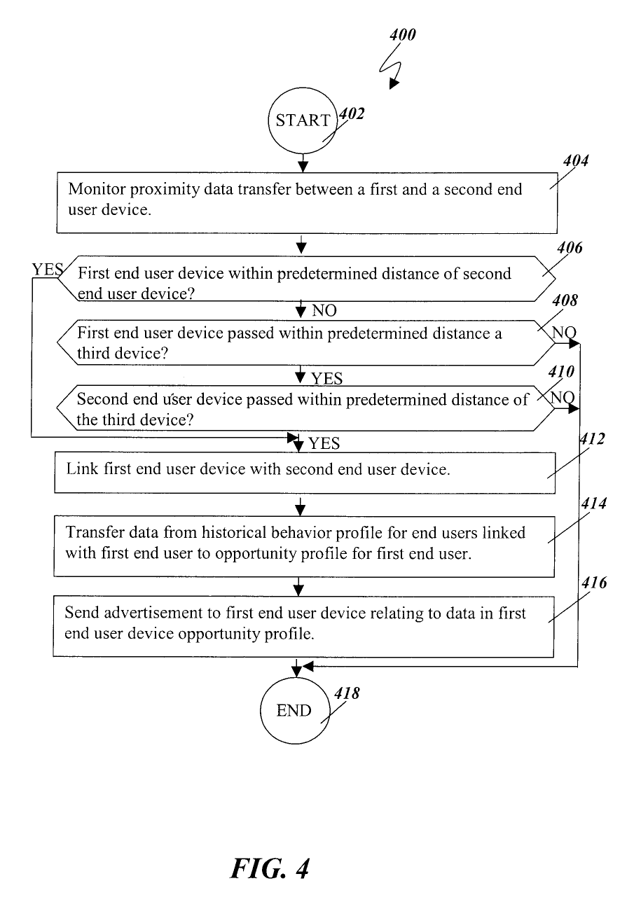

Turning now to FIG. 4 a flowchart 400 illustrates functions performed in an illustrative embodiment is depicted. The flowchart is not restrictive as to the order of functions performed or not intended to mean that any of the functions performed are necessary to practice the invention. That is, any of the functions may be performed in any order and as well maybe entirely left out of execution. Moreover, any and all embodiments disclosed herein may be combined in to any combination to form another embodiment.

As shown in FIG. 4 the function starts at terminal 402 and proceeds to block 404 wherein an illustrative embodiment monitors proximity data transfers between end users. Thus when a first end user and a second end user come within a predetermined distance of one another, for example, a data transfer of proximity data occurs between end users or between one of the end-user's and a third device. At block 406 an illustrative embodiment determines if the first end user device is within a predetermined distance of a second end-user device and if not proceeds to block 408 and determines if the first end user device has passed within range of a third proximity device. If yes, the illustrative embodiment then proceeds to block 410 where the illustrative embodiment determines whether the second end user device has also passed within range of the third device. If yes, then the illustrative embodiment links the first end user device with a second end user device, placing them in the same social network.

In a particular embodiment the second end user associated with the second end user device is placed in the social network for the first end user associated with the first end user's devices, that is proximity data is placed in the proximity list for the first end user, indicating that the second end is associated with the first end user via a proximity event as discussed above. If it is determined at block 406 that the first end user device is within the range of the second end user device an illustrative embodiment proceeds to block 412. If at block 408 an illustrative embodiment determines that the first end user device did not pass within a predetermined distance of a third device, an illustrative embodiment proceeds to terminal 418 and ends. If it is determined at block 410 that a second end user device did not pass within a predetermined distance of the third device, the illustrative embodiment proceeds to terminal 418 and ends. At block 414 al illustrative embodiment transfers data from a historical behavior profile for end users linked (placed in a social network) with the first end user to the opportunity profile for the first end user as discussed above. At block 416 advertising data is sent to the first end user device relating to data in the first end user device is opportunity profile. The flowchart ends at terminal 418.

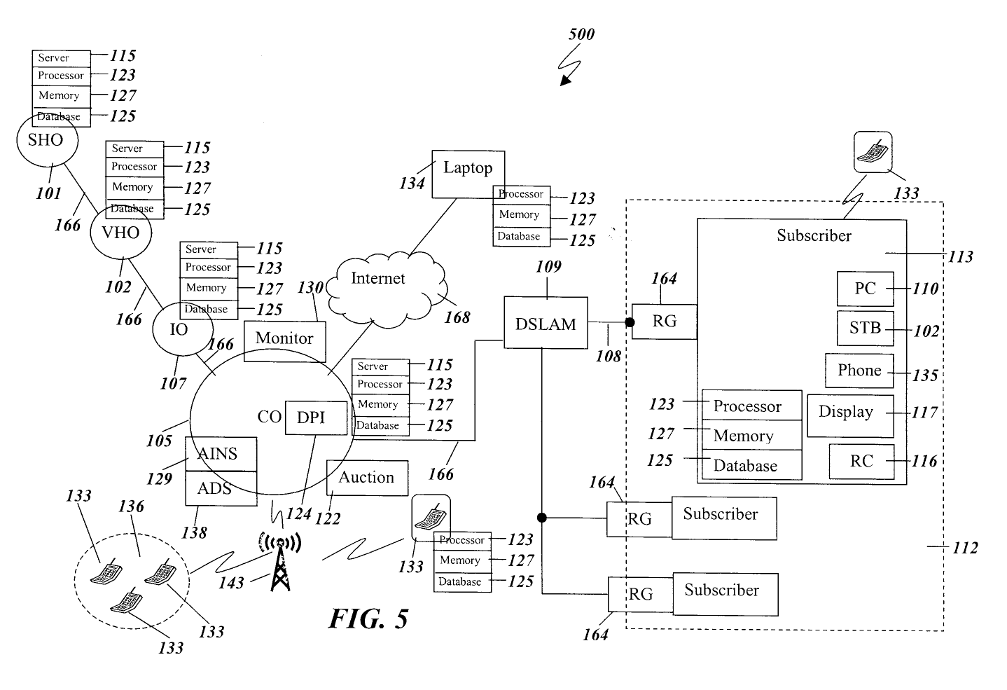

Turning now to FIG. 5, in an illustrative embodiment an Internet protocol television (IPTV) triple play system 500 provides Internet, telephone and IPTV data services to end-user devices including wireless and WiFi mobile telephones. The IPTV system also provides the advertising data to end user devices based on proximity events as discussed above. A server in the IPTV system keeps track of proximity data transferred between end user devices and third party (non-end user devices) proximity devices such as proximity devices at merchants or car lots which provide third party proximity devices and keeping track of end user devices coming with a predetermined distance of the third party proximity devices. A proximity device can also be placed in a moving vehicle. As shown in FIG. 5, the IPTV system 500 delivers video content data and targeted advertising data to subscriber house holds 113 and associated end user devices (also referred to herein as subscriber devices) which may be inside or outside of the household. Advertising data is inserted or marked as available by the advertising server 138.

In the IPTV system, IPTV video data are first broadcast in an internet protocol (IP) from a server at a super hub office (SHO) 101 to a regional or local IPTV video hub office (VHO) server 103, to a central office (CO) server 105 and intermediate office (10) 107. The IPTV system 100 includes a hierarchically arranged network of servers wherein the SHO transmits video and advertising data to a video hub office (VHO) 103 and the VHO transmits to an IPTV server location close to a subscriber, such as a CO server 105 or 10 107. In another particular embodiment, each of the SHO, VHO, CO, and 10 is interconnected with an IPTV transport 166. The IPTV transport 166 may consist of high speed fiber optic cables interconnected with routers for transmission of internet protocol data. The IPTV servers also provide data communication for data and video associated with Internet and VoIP services to subscribers. End users can access the internet 168 and WiFi cellular phone system 143 via the triple IPTV system.

Actively viewed IPTV channels are sent in an Internet protocol (IP) data multicast group to access nodes such as digital subscriber line access multiplexers (DSLAMS) 109. A multicast for a particular IPTV channel is joined over a DSL line 108 by the set-top boxes (STBs) at IPTV subscriber homes from the DSLAM. Each STB includes processor 123, a memory 127, and a database 125. Each SHO, VHO, CO and IO includes a server 115, processor 123, a memory 127, and a database 125. The processor 123 further includes a network interface. The processor reads computer programs containing executable instructions from a computer readable medium such as memory 127. The network interface functions to send and receive data over the IPTV transport 166 and DSL line 108. The CO server delivers IPTV, Internet and VoIP video content and data to non-mobile subscriber end user proximity devices and end user devices via the DSLAM. The television, internet and VoIP data and content can be delivered via multicast and unicast television advertising depending on a single subscriber or a targeted television advertising group of end user client subscriber devices to which the advertising data is directed.

In another particular embodiment, end user proximity devices, including but not limited to, wire line phones 135, portable cellular and WiFi phones 133, mobile computer 134 personal computers (PC) 110 and STB 102 communicate with a communication system, e.g., IPTV system through residential gateway (RG) 164 and high speed communication lines 108 and 166 and WiFi cellular network 143. In another particular embodiment, deep packet inspection (DPI) device 124 inspects VoIP, Internet and IPTV video data, data, commands and Meta data transmitted between the subscriber devices (subscriber activity data) and the IPTV system servers. Thus, when the three end user proximity devices 133 come within a predetermined distance of each other 136, a proximity event occurs and proximity data is sent to the CO server data base 125 and stored in data structures as describe above.

In another illustrative embodiment proximity data are monitored and collected whether or not the subscriber's devices are in the household 113 or traveling as mobile devices outside of the household. When outside of the household, proximity data and purchase transactions data are monitored by a communication network (e.g., IPTV system) servers or nodes which associate the subscriber activity data with particular subscriber's end user devices. In another particular embodiment, subscriber activity data such as communication and purchase transactions are inspected by DPI devices located in a communication system, e.g., IPTV system servers. These communication system servers route the subscriber activity data to an IPTV server such as the CO in which the subscriber activity data for a subscriber (end user) are stored in end user behavior profiles for processing. While an IPTV system has been used as an example in the illustrative embodiment, the disclosure is not meant to be limited to IPTV as other communication systems such as cable television or other digital and analog data delivery systems can be used in other embodiments.

In another particular embodiment, the end user proximity devices further include but are not limited to a client user computer, a personal computer (PC), a tablet PC, a set-top box (STB), a Personal Digital Assistant (PDA), a cellular telephone, a mobile device, a palm computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge or any machine capable of executing a set of instructions (sequential or otherwise) that specify actions to be taken by that machine. In another particular embodiment, a DPI device 124 inspects multicast and unicast data, including but not limited to VoIP video and data, Internet video and data and IPTV video and data, commands and Meta data between the subscriber end user devices and the IPTV system servers and the Internet.

In another illustrative subscriber activity data and proximity data are monitored and collected whether or not the end user proximity devices are in the household 113 or the devices are mobile outside of the household. Transactions are collected on all end user devices associated with an end user including non-proximity devices such as cell phones or computer with out proximity data sensing and transfer capability. When outside of the household, subscriber mobile device data are monitored by communication system (e.g., IPTV system) servers which associate the subscriber activity data with each particular subscriber's end user device. In another particular embodiment, subscriber activity data such as IPTV and Internet video selections, and communication and purchase transactions are inspected by DPI devices located in a communication system, e.g., IPTV system servers. These communication system servers route the subscriber activity data to a CO server data base 125 in which the subscriber activity data for a subscriber are stored for processing and become part of the historical behavior profile for the end user.

As shown in FIG. 5 advertising sub groups 112 (comprising a group of subscriber (also referred to herein as (end user)) house holds 113) receive multicast advertising data at STB 102 in a video data stream from CO server 107 and DSLAM 109. Individual households 113 receive advertising data at set top box 102 or one of the other subscriber devices. More than one STB 102 can be located in an individual household 113 and each individual STB can receive a separate multicast or unicast advertising stream on IPTV transport 166. In another particular illustrative embodiment, separate and unique advertising data are sent to each set top box (STB) 102 tailored to target the particular subscriber watching television at that particular STB. Each STB 102 has an associated remote control (RC) 116 and video display 117. The subscriber via the RC selects channels for a video data viewing selection (video programs, games, movies, video on demand) and places orders for products and services over the IPTV system 500.

FIG. 5 depicts an illustrative communication system, including but not limited to a television advertising insertion system wherein television advertising data can be inserted at an IPTV server (SHO, VHO, CO, IO) for delivery to an end user device, for example, an STB, mobile phone, web browser or personal computer. Advertising data can be inserted into or made available during replay of IPTV or other video data stored at an end user device. The advertising data is delivered via advertising insertion device 129 located at the IPTV CO server or at one of the end user devices such as the STB 102 which inserts the advertising data into video data. The IPTV servers include an advertising server 129 and an advertising database 138. The advertising data is selected by advertising selection element 129 from the advertising database 138 based on an auction for an available advertising spot based on a subscriber profile and delivered by the VHO advertising server 138. An SHO 101 distributes data to a regional VHO 103 which distributes data to local COs 105 which distribute data to a digital subscriber access line access multiplexer (DSLAM) access node to subscriber devices such as STB 102, PC 110, wire line phone 135, mobile phone 133, etc. Advertising data is also selected based on the subscriber profile and sent to a mobile phone or computer associated with the subscriber. The subscriber profile is built based on a subscriber's IPTV, Internet and VoIP activity.

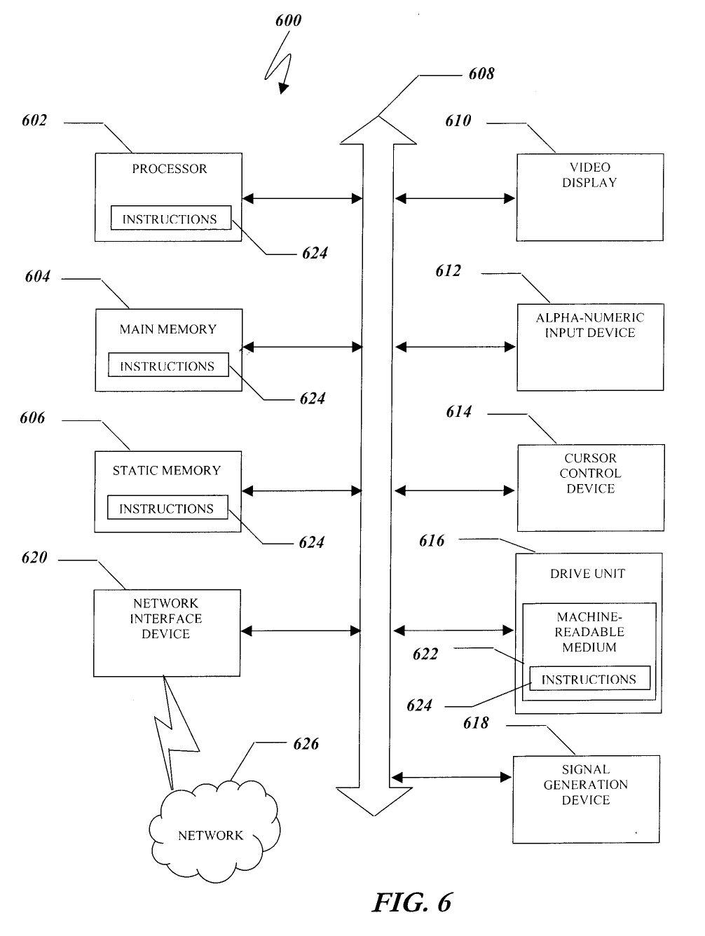

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein. The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein. The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Any embodiment or portion of any embodiment disclosed herein may be combined with any other embodiment or portion of any other embodiment disclosed herein for use as an illustrative embodiment. Any portion of any illustrative embodiment disclosed herein may also be deleted from an illustrative embodiment. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer readable medium containing computer executable instructions that when executed by a computer perform a method for selecting advertising data, the method comprising:
monitoring proximity data indicating proximity between a first end user device and at least one second device;
examining historical behavior profile data for the second device;
placing data from the historical behavior profile data into an opportunity profile for the first end user device based on the proximity data; and
selecting advertising data to be sent to the first end user device relating to the data placed in the opportunity profile.

2. The medium of claim 1, wherein one of the first end user device and the second device further comprise a plurality of end user devices associated with a plurality of end users.

3. The medium of claim 1, wherein the historical behavior profile further comprises purchase transaction data for an end user associated with the second device.

4. The medium of claim 1, wherein the historical behavior profile data further comprise data indicating that the second device came within a predetermined distance of a third device.

5. The medium of claim 1, wherein the historical behavior profile data further comprise subscriber activity data for an end user associated with the second device.

6. The medium of claim 1, wherein the second end user device further comprises a plurality of end user devices associated with a plurality of end users.

7. The medium of claim 1, wherein the proximity data further comprise proximity data transferred between the first end user device and the second device when the first end user device and the second device come within a predetermined distance of each other.

8. The medium of claim 1, wherein the proximity data further comprise data indicating a proximity event selected from the group consisting of the first end user device storing contact information for the second device, the first end user device sending an email to the second device, the first end user device sending a short messaging service (SMS) message to the second device and the first end user device placing a phone call to the second device.

9. The medium of claim 1, wherein the proximity data further comprises proximity data for the first end user device transferred between the first end user device and a third device when the first end user device and the third device come within a first predetermined range of each other; and proximity data for the first end user device transferred from the third device to the second device when the second device and the third device come within a second predetermined range of each other.

10. The medium of claim 8, wherein the proximity data are weighted based on a factor selected from the group consisting of time of day, day of the week and frequency of occurrence of the proximity event.

11. The medium of claim 1, wherein the historical behavioral profile data further comprise data indicating the first end user device and second device coming within a predetermined distance of a third device within a predetermined time.

12. The medium of claim 1, wherein the proximity data indicates that the first end user device and the second device are associated with end users in a social network.

13. A system for selecting advertising data, the system comprising:
a processor in data communication with a computer readable medium; and
a computer program embedded in the computer readable medium containing computer executable instructions, the computer program comprising instructions to monitoring proximity data indicating proximity between a first end user device and at least one second device, instructions to examine a historical behavior profile data for the second device, instructions to place data from the historical behavior profile data into an opportunity profile for the first end user device based on the proximity data and instructions to select advertising data to be sent to the first end user device relating to the data placed in the opportunity profile.

14. The system of claim 13, wherein one of the first end user device and the second device further comprise a plurality of end user devices associated with a plurality of end users.

15. The system of claim 13, wherein the historical behavior profile further comprises purchase transaction data for an end user associated with the second device.

16. The system of claim 13, wherein the second end user device further comprises a plurality of end user devices associated with a plurality of end users.

17. The system of claim 13, wherein the proximity data further comprise proximity data transferred between the first end user device and the second device when the first and second devices come within a predetermined distance of each other.

18. The system of claim 13, wherein the proximity data further comprise data indicating a proximity event selected from the group consisting of the first end user device storing contact information for the second device, the first end user device sending an email to the second device, the first end user device sending a short messaging service (SMS) message to the second device and the first end user device placing a phone call to the second device.

19. The system of claim 13, wherein the proximity data further comprises proximity data for the first end user device transferred between the first end user device and a third device when the first end user device and the third device come within a first predetermined range of each other; and proximity data for the first end user device transferred from the third device to the second device when the second device and the third device come within a second predetermined range of each other.

20. A computer readable medium containing computer executable instructions that when executed by a computer perform a method for receiving advertising data, the method comprising:
transferring proximity data between a first end user device and a second device indicating proximity between the first end user device and the second device; and
receiving targeted advertising data at the first end user device based on data from a historical behavior profile placed into an opportunity profile for the first end user device.

21. An apparatus for receiving advertising data comprising:
a processor in data communication with a computer readable medium; and a computer program stored in the computer readable medium containing computer executable instructions that when executed by a computer perform a method for selecting advertising data, the computer program comprising instructions to transfer proximity data between a first end user device and a second device indicating proximity between the first end user device and the second device and instructions to receive targeted advertising data at the first end user device based on data from a historical behavior profile data for the second device placed into an opportunity profile for the first end user device.

22. A data structure embedded in a computer readable medium for containing data useful in performing a method for selecting targeted advertising data to end user devices based on proximity data, the data structure comprising:
a first field for containing proximity data indicative of a secondary end user proximity device that has come into proximity with a primary end user proximity device;
a second field for containing data indicative of a historical behavior profile for a secondary end user associated with the secondary end user proximity device; and
a third field for containing data indicative of an opportunity profile for a first end user associated with the first end user device wherein the from data is moved from the historical behavior profile to the opportunity profile for the primary end user proximity device for selecting targeted advertising data to be sent to the primary end user proximity device based on the data in the opportunity profile.
